(19) United States
(12) Patent Application Publication
(10) Pub. No.: US 2012/0176859 A1
(43) Pub. Date: Jul. 12, 2012

(54) MARINE SEISMIC STREAMERS

(75) Inventors: Jahir Pabon, Newton, MA (US); Oeyvind Teigen, Slependen (NO)

(73) Assignee: Schlumberger Technology Corporation, Cambridge, MA (US)

(21) Appl. No.: 13/004,419

(22) Filed: Jan. 11, 2011

(51) Int. Cl. G01V 1/38; B32B 37/02

(52) U.S. Cl. 367/20; 156/293; 977/742; 977/903

(57) ABSTRACT

The subject disclosure relates to seismic streamers. More specifically, the subject disclosure relates to seismic streamers with self healing properties.

### FIELD OF THE DISCLOSURE

The subject disclosure relates generally to the field of marine seismic data acquisition equipment. More specifically, the subject disclosure relates to structures for a marine seismic streamer, and methods for making such streamers.

### BACKGROUND OF THE DISCLOSURE

In order to perform a 3D marine seismic survey, an array of marine seismic streamers, each typically several thousand meters long and containing a large number of sensors and associated electronic equipment distributed along its length, is towed at about 5 knots behind a seismic survey vessel, which also tows one or more seismic sources, typically air guns. Acoustic signals produced by the seismic sources are directed down through the water into the earth beneath, where they are reflected from the various strata. The reflected signals are received by the sensors in the streamers, digitized and then transmitted to the seismic survey vessel, where they are recorded and at least partially processed with the ultimate aim of building up a representation of the earth strata in the area being surveyed.

A typical marine seismic streamer is made up of a large number of similar 100 meter streamer sections connected end-to-end. Typically, each active streamer section of commercially available streamer is made up of a flexible sealed tubular outer jacket manufactured from polyurethane or a similar material. Multiple strength members, generally between two and five in the form of cables made of steel or other high strength materials, such as those sold under the trade names of Kevlar or Vectran, are spaced apart radially around the longitudinal axis of the cable and run along the entire length of the active cable section. Typically, the strength members are deployed near the inside surface of the flexible tubular member to absorb the pulling forces when the streamer is towed behind the vessel. Conventionally, the seismic streamers contain pressure sensors such as hydrophones, but seismic streamers have been proposed that contain water particle velocity sensors such as geophones or particle acceleration sensors such as accelerometers, in addition to hydrophones. The pressure sensors and particle motion sensors may be deployed in close proximity, collocated in pairs or pairs of arrays along a seismic cable. Hydrophones are typically placed in the center space between the radially spaced strength members. To detect very small reflections from the subterranean formations, groups of hydrophones equally spaced along the longitudinal axis of an active streamer section (typically spacing of approximately 3 meters between hydrophones) are placed in each active streamer section.

The hydrophones are substantially uniformly distributed along the length of the streamer section, and are interspersed with cylindrical spacers and foam elements which are mounted on the strength members, the foam elements being saturated in use with kerosene or a similar fluid to render the streamer section substantially neutrally buoyant. The fluid is typically kerosene because of its acoustic properties as well as its low density.

The streamer also includes electronics modules (or “bubbles”) containing circuitry for digitizing the reflected signals detected by the hydrophones and transmitting the digitized signals to the seismic survey vessels, these modules typically being connected between adjacent streamer sections.

Fluid filled streamer cables suffer from a number of problems. The outer jacket is typically only a few millimeters thick and thus, is, easily penetrated by shark bites or other physical hazards encountered during towing, storage and deployment. Moreover, fluid-filled streamer cables are normally spooled onto large drums for storage on the vessels and often rupture during winding (spooling) and unwinding operations. Additionally, the outer jacket can be easily ruptured during towing when fishing boats inadvertently pass over the streamer and damage the streamer jacket on contact. Fish bites or streamer entanglement with offshore structures can also rupture the outer jacket. Seismic survey companies spend large amounts of money in repairing such cables and are typically forced to keep excessive inventory of such cables as spares for damaged cables.

The fluid in the fluid-filled streamer is typically kerosene which is toxic and highly flammable, creating safety, health and environmental problems. Moreover, streamer filler fluid leaking into the ocean is hazardous to marine life. Recently, because of environmental concerns, mainly regarding the spill of kerosene, the marine seismic industry is moving away from fluid fillers.

Fluid filled streamer cables are but one of numerous designs and configurations known in the art. Gel-filled and solid streamers are also employed. Solid streamer cables, i.e. streamer cables with solid void-fillers, have been developed in an attempt to address the problems of liquid-filled streamer cables. A common type of solid streamer cable includes a solid central core with sensors, skin, buoyant material, and other various components installed thereabout. Another type of solid streamer cable includes alternating sections of sensors and buoyant material. As an alternative to liquid-filled cables, solid streamer cables have superior leakage and bulge wave reduction qualities, but present other difficulties of their own. Gel-filled streamers are filled with a gel filler which may consist of a nonhazardous, petroleum-based synthetic urethane polymer.

The presently disclosed subject matter addresses the problems of the prior art. It is desirable to have a seismic streamer comprising a material with self-healing properties. Further, it is desirable to have a fluid filled seismic streamer in which environmental concerns are handled through the use of a streamer material with self-healing properties.

### SUMMARY OF THE DISCLOSURE

It is an object of the subject disclosure to provide a marine seismic streamer exhibiting improvements over the known type of streamer.

According to one aspect of the subject disclosure, a seismic streamer comprising a core which has at least one longitudinally extending strength member and a plurality of sensors in the core is disclosed. The seismic streamer further comprises an outer skin surrounding the core and an absorbent foam material adapted to be self-healing.

In accordance with a further embodiment of the subject disclosure, a seismic streamer, comprising a jacket covering an exterior of the streamer is disclosed. The seismic streamer further comprises at least one strength member extending along the length of the jacket, the strength member disposed inside the jacket. Sensors are disposed at spaced apart locations along the interior of the jacket. Finally, the seismic streamer comprises a self-healing material which selectively absorbs oil in preference to water.

In accordance with a further embodiment of the subject disclosure, a method for making a seismic streamer is disclosed. The method comprises inserting at least one strength member and seismic sensors into a core. The method further comprises surrounding the core with an outer skin and introducing an absorbent foam material adapted to be self-healing.

In accordance with a further embodiment of the subject disclosure, a method of preventing fluid leaks from a seismic streamer is disclosed. The method comprises inserting at least one strength member and seismic sensors into a core and surrounding the core with an outer skin and introducing an absorbent foam material adapted to be self-healing.

Further features and advantages of the subject disclosure will become more readily apparent from the following detailed description when taken in conjunction with the accompanying drawings.

### BRIEF DESCRIPTION OF THE FIGURES

FIG. 1 is a somewhat diagrammatic representation of a seismic survey vessel towing a marine seismic streamer in accordance with the subject disclosure in a body of water in order to perform a marine seismic survey;

FIG. 2 is a cross-sectional view of part of the streamer of FIG. 1;

FIG. 3 is a cross-sectional view of an embodiment of a fluid filled streamer in accordance with the subject disclosure;

FIG. 4 is a cross-sectional view of an alternative embodiment of a fluid filled streamer in accordance with the subject disclosure;

FIG. 5 is a cross-sectional view of an alternative embodiment of a fluid filled streamer in accordance with the subject disclosure;

FIG. 6 is a cross-sectional view of an alternative embodiment of a fluid filled streamer in accordance with the subject disclosure; and

FIG. 7 is a cross-sectional view of an alternative embodiment of a solid filled streamer in accordance with the subject disclosure.

### DETAILED DESCRIPTION

Embodiments herein are described with reference to marine seismic streamers. Further, embodiments of the subject disclosure disclose marine seismic streamers comprising a streamer material with self-healing properties which prevents kerosene leaks due to streamer damage. Embodiments of the subject disclosure provide a significant advantage as environmental concerns regarding the spill of kerosene are now handled through the use of a streamer material with self-healing properties.

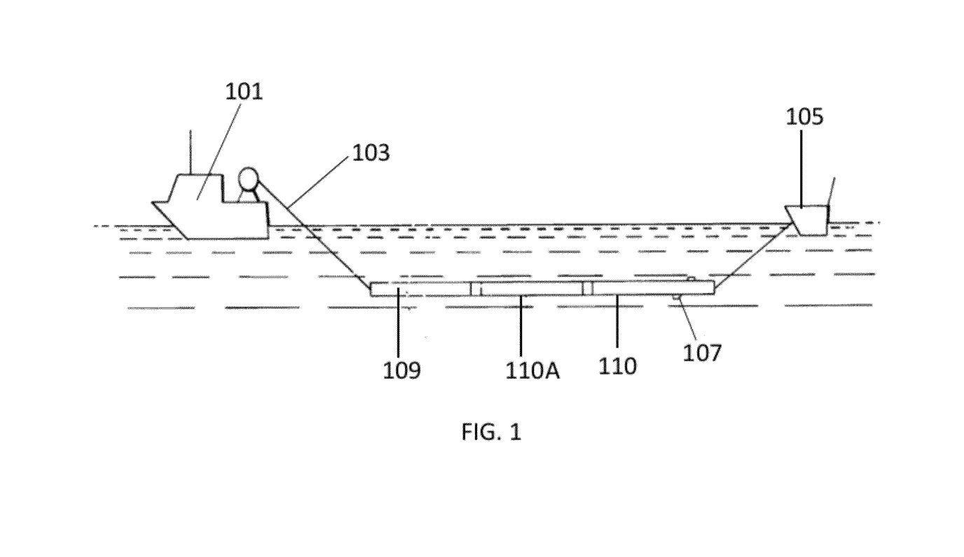

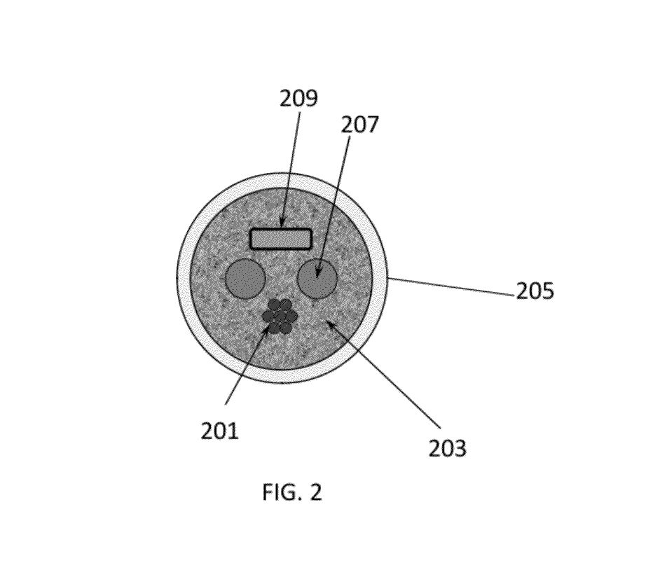

FIG. 1 shows at 110 a streamer in accordance with the subject disclosure being towed in the sea by a seismic survey vessel 101, in order to perform a marine seismic survey of the seabed beneath the streamer 110 and the vessel 101. The streamer 110 is towed at a depth of about 6 to 10 meters below the surface of the water by means of its lead-in 103 i.e. by means of the reinforced electro-optical cable via which power and control signals are supplied to the streamer and seismic data signals are transmitted from the streamer back to the vessel, the depth of the streamer being controlled, in known manner by depth controllers, or “birds”, 107 distributed along the length of the streamer. Position control devices, such as depth controllers, paravanes, and tail buoys are affixed to the streamer at selected positions and are used to regulate and monitor the movement of the streamer in the water. Typically, the front end of the streamer 110 is mechanically coupled to the lead-in 103 by at least one vibration-isolating section (or “stretch section”) 109, while the rear end is coupled to a tailbuoy 105 incorporating a GPS position measuring system, typically via another “stretch section” which has been omitted from FIG. 1 for the sake of simplicity. The streamer 110 is made up from a plurality of similar 100 meter streamer sections 110A connected end-to-end. Part of one of these streamer sections 110A is shown in more detail in FIG. 2.

FIG. 2 is a cross-sectional view of a typical marine seismic streamer section (110A in FIG. 1), where it can be seen that the streamer section comprises a core 203 filled with polyurethane foam saturated with kerosene, surrounded by a outer jacket 205 which is typically polyurethane, but other plastics materials can be used if desired. In general, the material in the core 203 has a density to make the overall streamer neutrally buoyant; and the material typically has properties that make the material acoustically transparent and electrically non-conductive. Certain fluids (kerosene, for example) possess these properties and thus, may be used as streamer filler materials. The major components of the streamer section are embedded in the core 203. These major components include uniformly longitudinally spaced sensors and electronics 209, a pair of parallel, longitudinally extending, woven Kevlar rope strength members (or “stress members”) 207, and wires for power communication etc. 201. The strength members 207 extend the length of the segment 110A and transmit axial force along the length of the segment 110A. The sensors, in the subject disclosure may be hydrophones, velocity sensors, motion sensors, accelerometers or the like. In other embodiments, the sensors may be particle motion sensors such as geophones, or accelerometers.

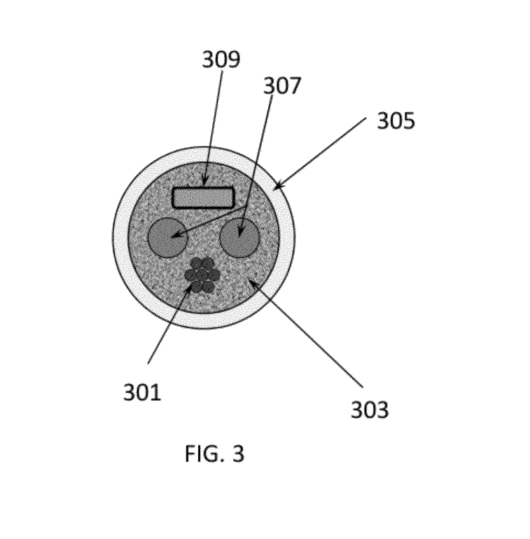

FIG. 3 is a cross-sectional view of an embodiment of the subject disclosure, where it can be seen that the streamer section comprises a core 303 filled with a foam material saturated with kerosene which can selectively absorb oil and volatile chemicals in preference to water. In one non-limiting example, embodiments of the subject disclosure comprise absorbent foam material with the ability to selectively absorb oil in preference to water. In one non-limiting example, this absorbent foam material is a carbon nanotube sponge-like material as described in Gui et al., entitled “Carbon Nanotube Sponges”, Adv. Mater. 2010, 22, 617-621, the contents of which are herein incorporated by reference. Nanotubes are unique cylindrical structures with remarkable electronic and mechanical properties. The sponge is built entirely with nanotubes through a random interconnection. The sponges have the ability to absorb up to almost 180 times their own weight in oil, giving them great potential for mopping up leaked kerosene. The sponge utilizes nanotubes that are as long as possible but are in a disordered arrangement. A chemical vapor deposition (CVD) process is used to make an amorphous mix of multi-walled nanotubes hundreds of micrometers long. These carbon nanotube sponges have a low density as the arrangement of the nanotubes creates large empty pores. This absorbent foam material acts as a self healing material thus eliminating or minimizing the spillage of kerosene fluid inside the streamer in situations where ruptures or mechanical damage may have occurred to the outer jacket of the streamer. The absorbent foam material in a densified state swells instantaneously upon contact with organic solvents thus providing a self-healing material which seals instantaneously. Surrounding the absorbent foam material 303 is an outer jacket 305 which is typically polyurethane, but other plastics materials can be used if desired. The major components of the streamer section are embedded in the core 303. These major components include uniformly longitudinally spaced sensors and electronics 309, a pair of parallel, longitudinally extending, woven Kevlar rope strength members (or “stress members”) 307, and wires for power communication etc. 301. It is to be understood that other absorbent foam material is contemplated and may be used without departing from the scope or spirit of the present disclosure.

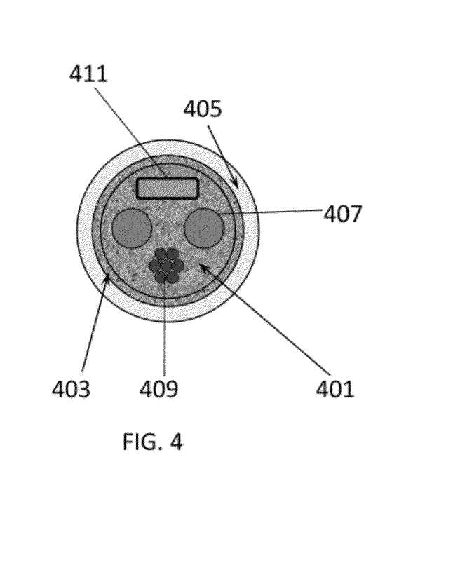

FIG. 4 is a cross-sectional view of a further embodiment of the subject disclosure, where it can be seen that the streamer section comprises a core 401 filled with polyurethane foam saturated with kerosene, surrounded by a outer jacket 405 which is typically polyurethane, but other plastics materials can be used if desired. The outer jacket 405 defines an annular gap 403 around the core 401. This annular gap 403 is substantially filled with the absorbent foam material as described above. The major components of the streamer section are embedded in the core 401. These major components include uniformly longitudinally spaced sensors and electronics 411, a pair of parallel, longitudinally extending, woven Kevlar rope strength members (or “stress members”) 407, and wires for power communication etc. 409.

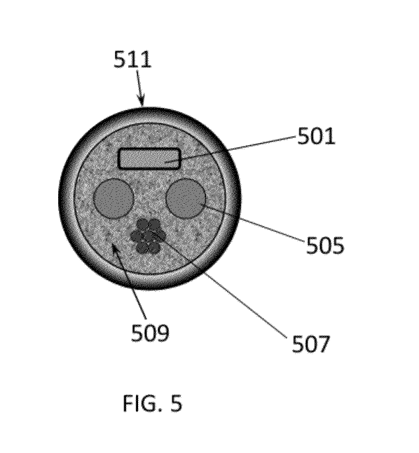

FIG. 5 is a cross-sectional view of a further embodiment of the subject disclosure, where it can be seen that the streamer section comprises a core 509 filled with polyurethane foam saturated with kerosene, surrounded by a outer jacket 511 comprising a material with graded properties, the inner layers can be considered to have a material similar to the absorbent foam material as described above while the outer layers comprise a material which is typically polyurethane, but other plastics materials can be used if desired. The major components of the streamer section are embedded in the core 509. These major components include uniformly longitudinally spaced sensors and electronics 501, a pair of parallel, longitudinally extending, woven Kevlar rope strength members (or “stress members”) 505, and wires for power communication etc. 507.

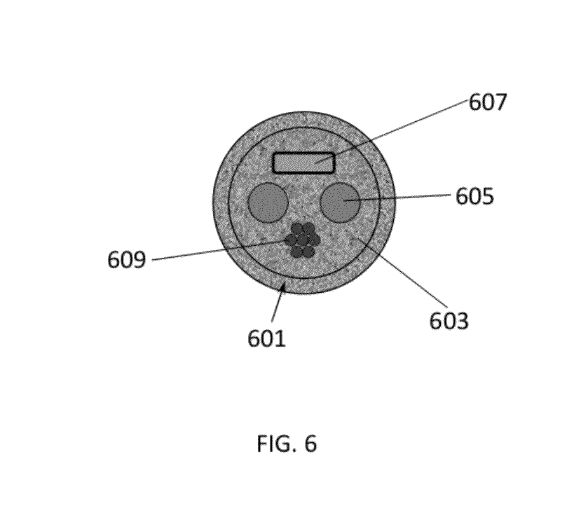

FIG. 6 is a cross-sectional view of a further embodiment of the subject disclosure, where it can be seen that the streamer section comprises a core 603 filled with polyurethane foam saturated with kerosene, surrounded by an outer jacket 601 comprising a compounded material with the ability to selectively absorb oil in preference to water. This compounded material in one non-limiting example comprises polyurethane, but other plastics materials can be used if desired and absorbent foam material as described above. The resultant compounded material has the ability to selectively absorb oil in preference to water. The major components of the streamer section are embedded in the core 603. These major components include uniformly longitudinally spaced sensors and electronics 607, a pair of parallel, longitudinally extending, woven Kevlar rope strength members (or “stress members”) 605, and wires for power communication etc. 609.

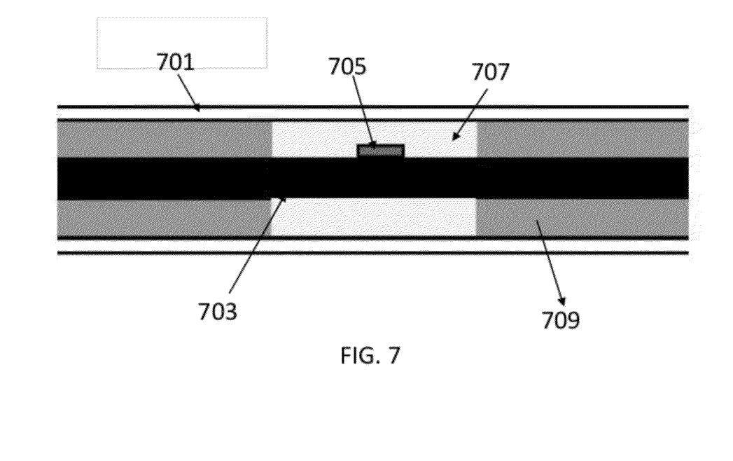

FIG. 7 is a cross-sectional view of a further embodiment of the subject disclosure, where it can be seen that the streamer section comprises a hard solid core 709, surrounded by a soft plastics outer skin 701. The plastics material of the core 709 and the outer skin 709 is typically polyurethane, but other suitable plastics material can be used if desired. The major components of the streamer section are embedded in the core 709. These major components include uniformly longitudinally spaced sensors and electronics 705, a tension carrying rope 703, and wires for power communication etc. (not shown). The sensors and electronics 705 are contained within an absorbent foam material as described above saturated with kerosene which envelops the sensors. The advantages of this absorbent foam material are twofold; the absorbent foam material prohibits kerosene from leaking out of the streamer and prohibits sea water from leaking in and short-circuiting the electronics causing a failure of the system. Acquisition hardware is typically situated in voids inside the hard plastic filler 709.

It is to be understood that other embodiments are contemplated and may be made without departing from the scope or spirit of the present disclosure. These may include other materials with self-healing properties used in a streamer. These materials upon exposure to kerosene will exhibit a structural change that prevents the flow of kerosene across the outer jacket of the streamer. While the subject disclosure is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the subject disclosure should not be viewed as limited except by the scope and spirit of the appended claims.

What is claimed is:

1. A seismic streamer comprising a core, at least one longitudinally extending strength member and a plurality of sensors in said core, an outer skin surrounding said core and an absorbent foam material adapted to be self-healing.

2. The streamer of claim 1 wherein the absorbent foam material is a carbon nanotube sponge.

3. The streamer of claim 1 wherein the absorbent foam material selectively absorbs oil in preference to water.

4. The streamer of claim 1 wherein the core is substantially filled with the absorbent foam material.

5. The streamer of claim 1 wherein the outer skin comprises an inner layer around the core and an outer layer around the inner layer.

6. The streamer of claim 5 wherein the inner layer comprises an absorbent foam material and the outer layer comprises polyurethane.

7. The streamer of claim 1 wherein the outer skin comprises a material with graded properties.

8. The streamer of claim 7 wherein the material comprises inner layers of an absorbent foam material and outer layers of polyurethane.

9. The streamer of claim 1 wherein the outer skin comprises a compounded material.

10. The streamer of claim 9 wherein the compounded material comprises polyurethane and an absorbent foam material and selectively absorbs oil in preference to water.

11. The streamer of claim 1 wherein the streamer is a solid streamer.

12. The streamer of claim 11 wherein the plurality of sensors in the core are embedded in an absorbent foam material.

13. The streamer of claim 1 wherein the outer skin comprises polyurethane.

14. The streamer of claim 1 wherein the plurality of sensors comprise one of a pressure sensor and a particle motion sensor.

15. The streamer of claim 1 wherein the absorbent foam material eliminates or minimizes a spill of kerosene fluid from the seismic streamer.

16. A seismic streamer, comprising:
a jacket covering an exterior of the streamer;
at least one strength member extending along the length of the jacket, the strength member disposed inside the jacket;
sensors disposed at spaced apart locations along the interior of the jacket; and
a self-healing material which selectively absorbs oil in preference to water.

17. A method for making a seismic streamer, comprising:
inserting at least one strength member and seismic sensors into a core;
surrounding the core with an outer skin; and
introducing an absorbent foam material adapted to be self-healing.

18. A method of preventing fluid leaks from a seismic streamer, the method comprising:
inserting at least one strength member and seismic sensors into a core;
surrounding the core with an outer skin; and
introducing an absorbent foam material adapted to be self-healing.
